(19) United States
(12) Patent Application Publication
(10) Pub. No.: US 2021/0094354 A1
(43) Pub. Date: Apr. 1, 2021

(54) Assembly for a Tire

(71) Applicant: COMPAGNIE GENERALE DES ETABLISSEMENTS MICHELIN, Clermont-Ferrand (FR)

(72) Inventor: Sylvain MORIVAL, Clermont-Ferrand Cedex 9 (FR)

(21) Appl. No.: 16/956,466

(22) PCT Filed: Dec. 17, 2018
(86) PCT No.: PCT/FR2018/053323

§ 371 Date: Jun. 19, 2020

(30) Foreign Application Priority Data
Dec. 20, 2017 (FR) 17/62578

(51) Int. Cl. B60C 7/24; B60C 7/12

(52) U.S. Cl. CPC B60C 7/24; B60C 2007/146; B60C 2200/12; B60C 7/12

(57) ABSTRACT

A non-pneumatic tire intended to be mounted on a rim and fitted to a lightweight vehicle, namely an assembly (A) for a tire, made up of a tire element (1) and of a clamping insert (9), and able to be wound onto a rim. To increase the load-bearing capability, the tire element (1) has two stiffening portions (6) at least partially not joined together, and each stiffening portion (6) extends in the open main interior cavity (5), from a transition zone between the bead (4) and the sidewall (3) as far as the vicinity of the middle of the crown (2), and delimits, with a portion of tire element (7) facing the stiffening portion (6), a closed secondary interior cavity (8). The clamping insert (9) may be a tape, with two transverse edges (91) inserted in the respective longitudinal grooves (41) of the two beads (4) of the tire element (1) so that to apply a clamping force to the two beads (4).

The present invention relates to a non-pneumatic tire intended to be mounted on a rim and fitted to a lightweight vehicle, and the subject of the present invention is more specifically an assembly for a tire, which is able to be wound onto a rim in order to constitute a non-pneumatic tire.

What is meant by a lightweight vehicle is a vehicle that has a low mass, for example a laden weight at most equal to 200 kg, travelling at low speed, for example at most equal to 50 km/h. A bicycle, a baby carriage, a wheelchair for the disabled are examples of lightweight vehicles. Although not limited to this application, the invention will be described more specifically for a non-pneumatic tire intended to be fitted to a lightweight two-wheeled vehicle of the bicycle type.

An assembly for a tire, within the meaning of the invention, is made up of a tire element and of a clamping insert. The tire element is a hollow tubular body usually comprising at least one polymer material. The clamping insert is a means of ensuring that the tire element is clamped onto a mounting rim. The assembly made up of the tire element and the clamping insert is intended to be wound onto a rim in order to constitute a non-pneumatic tire. The non-pneumatic tire mounted on its rim is referred to as a mounted assembly.

In the known way, a pneumatic tire is an open hollow toric body made up of at least one elastomer material, subjected to a determined inflation pressure which is dependent on the dimensional characteristics of the tire and on the demands intended to be placed upon it in terms of load and speed, as defined for example by the standards of the European Tire and Rim Technical Organization (the “ETRTO”). A tire usually comprises a tread intended to come into contact with the ground via a tread surface and connected by two sidewalls to two beads intended to collaborate with a rim.

It is also known that a pneumatic tire, inflated to a determined initial pressure, has the disadvantage of seeing a gradual reduction in its pressure over the course of time, hence the need to continuously monitor the pressure and potentially make pressure adjustments. This loss of pressure may be partial, in the event of a loss of sealing at the rim or of the tread being punctured, or may be a total loss of pressure, in the event of the tire bursting.

By definition, a non-pneumatic tire is a toric body made up of at least one polymer material, intended to perform the function of a tire but without being subjected to an inflation pressure. A non-pneumatic tire may be solid or hollow. A hollow non-pneumatic tire may contain air, but at atmospheric pressure, which is to say that it has no pneumatic stiffness afforded by an inflation gas at a pressure higher than atmospheric pressure.

A non-pneumatic tire advantageously makes it possible to eliminate the constraint of monitoring and adjusting the pressure and the risks of a partial or complete loss of pressure of a pneumatic tire.

The rim, on which a non-pneumatic tire is intended to be mounted, comprises two rim flanges connected by a rim base. A rim usually comprises a rim hole allowing the installation of an inflation valve. A rim may be made of a metallic or polymer or composite material.

Various designs of non-pneumatic tire have been proposed in the prior art. Of the non-pneumatic tires proposed, some have been designed to have effective clamping onto the rim. For example, patent application US 20120318421 A1 discloses a non-pneumatic tire made up of a closed hollow body made of elastomer material, fixed to a rim by a clamping element, positioned circumferentially on the inside of the non-pneumatic tire. This clamping element of the cord type comprises two ends, with respectively a locking end and a toothed end, joined together to provide the clamping, at a hole opening to the exterior surface of the non-pneumatic tire. This design has the disadvantage of having a rim-clamping element that can be difficult to insert into the non-pneumatic tire. Furthermore, such a non-pneumatic tire of a given dimension needs to be mounted on a rim of suitable size.

In order to overcome the above disadvantages, document WO 2017067869 proposes a mounted assembly comprising a non-pneumatic tire mounted on a rim, with easier mounting and rim-clamping and with flexible mountability, namely with the possibility of mounting on rims having axial widths that are different but similar, the relative difference being at most equal to 20%. The mounted assembly described in that document comprises a non-pneumatic tire mounted on a rim and a filamentary clamping insert applied to the entire radially interior circumference of the closed toric cavity of the non-pneumatic tire. The clamping insert comprises clamping means applying a preload that ensures clamping by compressing a radially interior portion of the non-pneumatic tire onto the rim. According to the invention, the non-pneumatic tire comprises at least one circumferential through-discontinuity, the radially interior portion of the non-pneumatic tire comprises two deformable beads geometrically fitting the rim under the action of the compressive clamping, and the clamping insert passes successively, radially towards the inside, through the radially interior portion of the non-pneumatic tire and through a hole in the rim, so that the clamping means are positioned radially on the inside of the rim. However, this non-pneumatic tire has the disadvantage of having excessive radial deformation or deflection when mounted on its rim and subjected to a nominal load as defined for example by the ETRTO standard. Excessive radial deflection may in particular lead to blistering, which is to say local detachment, of the central portion of the tread surface in the patch in which the tread surface is in contact with the ground. This blistering leads to impaired operation of the tread, particularly with regards to wear and grip. As a result, the load-bearing capability of such a non-pneumatic tire is not sufficient for optimal operation of the non-pneumatic tire. Furthermore, the non-pneumatic tire described in document WO 2017067869 has the particular feature of being able to be obtained by winding onto a rim a tire element that has been cut to a length substantially equal to the circumference of the rim.

The inventors have set themselves the objective of proposing an assembly for a tire, able to be wound onto a rim to constitute a non-pneumatic tire for a lightweight vehicle, such that the non-pneumatic tire thus obtained has an increased load-bearing capability by comparison with a hollow non-pneumatic tire of the prior art, with optimal rim-clamping.

This objective has been achieved by an assembly for a tire, made up of a tire element and of a clamping insert, and able to be wound onto a rim to constitute a non-pneumatic tire for a lightweight vehicle:
the tire element being a hollow tubular body having a longitudinal midline of length L and comprising at least one polymer material,
the tire element comprising a crown, intended to come into contact with the ground, and connected by two sidewalls to two beads which are intended to collaborate with the rim,
the assembly consisting of the crown, the two sidewalls and the two beads delimiting an open main interior cavity,
each bead of the tire element comprising a longitudinal groove opening onto an interior face of a bead, facing the open main interior cavity, and extending along the entire length L of the longitudinal midline of the tire element,
the clamping insert having a longitudinal length L1 at most equal to the length L of the longitudinal midline of the tire element,
the tire element comprising two stiffening portions at least in part not joined together,
each stiffening portion extending in the open main interior cavity from each bead as far as the crown and delimiting, with a portion of the tire element facing the said stiffening portion, a closed secondary interior cavity;
and the clamping insert being a tape, comprising two transverse edges inserted in the respective longitudinal grooves of the two beads of the tire element so that the clamping insert is configured to apply a clamping force to the two beads, as the assembly for a tire is wound onto the rim.

The subject of the invention is an assembly for a tire making it possible to achieve a non-pneumatic tire by winding the said assembly for a tire onto a rim. In other words, the non-pneumatic tire is produced directly on the rim by winding the assembly for a tire, generally comprising a tire element cut to a length L substantially equal to the circumference of the mounting rim, and a clamping insert cut to a length L1 at most equal to the length L. The assembly for a tire is closed circumferentially by butting together the end faces of the tire element thus cut, the abutment zone constituting a through-discontinuity. The longitudinal ends of the clamping insert are generally secured to one another, and if appropriate secured to the rim, at the through-discontinuity. This then is not a toric non-pneumatic tire manufactured beforehand and then mounted on the rim, but a non-pneumatic tire that it is produced its rim with the advantage that it can be made to fit rims of different circumferences.

The tire element is a hollow tubular body with a longitudinal midline of length L. By definition, the longitudinal midline of the tire element is the locus of the centres of gravity of the sections perpendicular to the said longitudinal midline and is positioned in a longitudinal midplane XZ passing through the middle of the crown. By convention, the direction XX′ is the longitudinal direction, tangential to the longitudinal midline, the direction ZZ′ is the direction perpendicular to the longitudinal midline and positioned in the longitudinal midplane XZ, and the direction YY′ is the transverse direction, perpendicular to the longitudinal midplane XZ.

The tire element comprises at least one polymer material, which is the type of material commonly used in the field of non-pneumatic tires.

The assembly consisting of the crown, the two sidewalls and the two beads delimits an open main interior cavity, this cavity being open at the beads. In other words, the beads are not joined together by a tire element portion. However, this open main interior cavity may contain at least one closed sub-cavity or secondary cavity.

Each bead comprises a longitudinal groove opening onto an interior face of a bead, facing the open main interior cavity, and extending along the entire length L of the longitudinal midline of the tire element. The presence of such a longitudinal groove in each bead in particular makes it possible to house the transverse edges of the clamping insert, joining the beads together and ensuring the clamping of the non-pneumatic tire onto its rim.

The assembly for a tire comprises a second element, which is a clamping insert having a longitudinal length L1 at most equal to the length L of the longitudinal midline of the tire element. Specifically, the clamping insert is designed to apply a clamping force over the entire circumference of the tire element, when the latter is wound onto its rim. Furthermore, it needs to be long enough that its longitudinal ends can be secured to one another, theoretically without overlap, which is why it has a length that is often slightly shorter than that of the tire element. This is because an overlap, namely a local superposition, of the longitudinal ends would not allow the fitting of a clamping insert in the specific instance in which the clamping insert is a tape, comprising two edges inserted in two respective longitudinal grooves in the two beads of the tire element.

According to a first feature of the invention, the tire element comprises two stiffening portions at least partly not joined together, which make it possible to improve the stiffness of the tire element with respect to compression. These two stiffening portions are partially disjointed with respect to one another and, in particular, in the open main interior cavity, so as to have mechanical behaviours that are essentially independent. They do not therefore, for example, constitute a latticework stiffening structure, and contribute to the stiffness essentially through their intrinsic shape and through the material of which they are made.

According to a second feature of the invention, each stiffening portion extends in the open main interior cavity from each bead as far as the crown and delimits, with a portion of the tire element facing the said stiffening portion, a closed secondary interior cavity. The geometric shape of each stiffening portion therefore provides bracing of the tire element, on either side of its longitudinal midplane. The main interior cavity is thus divided into two closed secondary cavities which are separated from one another by a third secondary cavity open at the beads. Usually, each stiffening portion extends in the open main interior cavity, from a region of transition between the bead and the sidewall, as far as the vicinity of the middle of the crown: this creates bracing between the middle of the crown and the bead, without interaction with the sidewall.

Finally, according to a third feature of the invention, the clamping insert is a tape, comprising two transverse edges inserted in the respective longitudinal grooves of the two beads of the tire element so that the clamping insert is configured to apply a clamping force to the two beads, as the assembly for a tire is wound onto the rim. The clamping is thus produced by means applied directly in the bead region. A tape form such as this for the clamping insert is both easy to manufacture and easy to assemble with the tire element.

The invention described hereinabove thus makes it possible to increase the load-bearing capability of a non-pneumatic tire, by comparison with a reference hollow non-pneumatic tire without a stiffening portion. The stiffening of the non-pneumatic tire leads to a reduction in the radial deformation of the crown, or deflection, and this makes it possible to ensure full contact between the tread surface and the ground, eliminating any risk of blistering, namely of local detachment of the tread surface in its middle portion.

Preferably, the two stiffening portions are symmetrical with respect to a longitudinal midplane, passing through the middle of the crown and containing the longitudinal midline of the tire element. Because the tire element is itself generally symmetrical with respect to its longitudinal midplane, the symmetry of the stiffening proportions ensures symmetrical behaviour of the non-pneumatic tire as it compresses onto the ground.

Preferably also, with each portion of the tire element facing a stiffening portion having, in any transverse plane perpendicular to the longitudinal midline of the tire element, a transverse curvature C₀, each stiffening portion has, in any transverse plane, a transverse curvature C₁ that has the opposite orientation to the transverse curvature C₀ of the portion of the tire element facing the stiffening portion. More specifically, because the transverse curvature C₀ of the portion of the tire element is concave, the transverse curvature C₁ of the stiffening portion is convex. As a result, upwards of a certain level of compression of the non-pneumatic tire, the two deformed stiffening portions are liable to come into contact with one another and, by bearing against one another via their respective exterior faces, to further increase the stiffness of the non-pneumatic tire with respect to compression.

The tire element is advantageously made of a single polymer material. This is the embodiment that is simplest from the design and manufacture perspective.

In the case of a single polymer material, the polymer material of which the tire element is made preferably has a Shore hardness at least equal to 70. Below that Shore hardness, the stiffening is insufficient. In a known way, the mechanical behaviour of an elastomer compound may be characterized, in particular, by its Shore hardness, measured in accordance with the standards DIN 53505 or ASTM 2240.

According to two particular embodiments of a polymer material that has a Shore hardness at least equal to 70, the polymer material of which the tire element is made is advantageously a thermoplastic elastomer material or a vulcanized thermoplastic material. These types of materials are commonly used in the field of non-pneumatic tires. They have the advantage of having modest curing temperatures, comprised between 120° C. and 250° C.

According to one advantageous embodiment, the tire element has a curved longitudinal midline with a monotonic radius of curvature R. A monotonic radius of curvature R is, in the mathematical sense, a radius that always has the same direction of variation. In other words, such a curved longitudinal midline of a tire element exhibits no inversion of curvature. The benefit of having a monotonic radius of curvature R is that it makes it easier, first of all, to wind the tire element onto a storage spool and then, secondly, that it makes it easier to place it by winding it onto a rim, by virtue of this preformed initial geometry. Specifically, in the case of a rectilinear tire element, which means to say one that has an infinite radius of curvature, during placement of the said element on a rim, the hollow tubular body may be subjected to buckling because of the great extension of its portion corresponding to the crown and because of the great compression of the portion corresponding to the beads. In contrast, in the case of a curved tire element, with a radius of curvature suited to the radius of the rim, the respective deformations of the portions corresponding to the crown and to the beads are limited and are not liable to cause the hollow tubular body to buckle. The radius of curvature R of the tire element is generally substantially constant and needs to be compatible with the radius of the rim to which the tire element is intended to be fitted. For a conventional bicycle, the radius of curvature R may typically be comprised between 200 mm and 500 mm.

According to a preferred variant of a clamping insert of the tape type, the clamping insert has, in any transverse plane, a cross section that is curved before the assembly for a tire is wound onto the rim. This curved cross section allows the clamping insert to be fitted more easily into the longitudinal grooves of the beads of the tire element as the assembly for a tire is being made up. Furthermore, as the assembly for a tire is being wound onto its rim, the curved cross section gives the assembly for a tire a deformability of the beads that makes for easier mounting of the beads on the rim flanges and allows it to be made to fit rims that have varying widths between rim flanges. After having been wound onto the rim, the cross section of the clamping insert has a curvature that is smaller by comparison with its initial curvature, or even substantially zero. As a result, on the made-up non-pneumatic tire, the cross section of the clamping insert may be substantially rectilinear.

Finally, the clamping insert is preferably made of a polymer material, preferably a plastic material. This type of material is customary and economical.

Another subject of the invention is a method for mounting an assembly for a tire, as previously described, on a rim.

The method for mounting an assembly for a tire, as previously described, on a rim, the assembly for a tire being made up of a tire element, having a longitudinal midline of length L extending between two longitudinal end faces, and a clamping insert, having a longitudinal length L1, measured between two longitudinal ends, at most equal to the length L, comprises:
a first step of circumferentially winding the assembly for a tire onto the rim,
a second step of setting the two beads of the tire element on the rim, by the collaboration between the clamping insert and the respective grooves of the two beads,
a third step of butting together the two longitudinal end faces of the tire element so as to constitute a non-pneumatic tire, the abutment zone constituting a circumferential through-discontinuity of the non-pneumatic tire.

Furthermore, the method for mounting an assembly for a tire described hereinabove advantageously comprises a fourth step of joining together the longitudinal ends of the clamping insert. This step allows the longitudinal ends of the clamping insert to be secured to one another and therefore makes it possible to avoid the circumferential through-discontinuity of the non-pneumatic tire opening up, by keeping the two longitudinal end faces of the tire element in contact with one another.

Finally, the method for mounting an assembly for a tire described hereinabove also advantageously comprises a fifth step of locking the longitudinal ends of the clamping insert to the rim. This step allows the non-pneumatic tire to be secured to the rim and makes it possible to avoid any shifting with respect thereto, such as any turning on the rim.

According to a preferred embodiment of this fifth step of locking the longitudinal ends of the clamping insert to the rim, the longitudinal ends of the clamping insert are fixed to the rim using locking means that pass through a hole in the rim, which hole is positioned circumferentially plumb with the circumferential through-discontinuity of the non-pneumatic tire. By way of example, these locking means may be a screw-nut system.

The invention is illustrated in the figures referenced hereinbelow, which are not to scale and are described below:

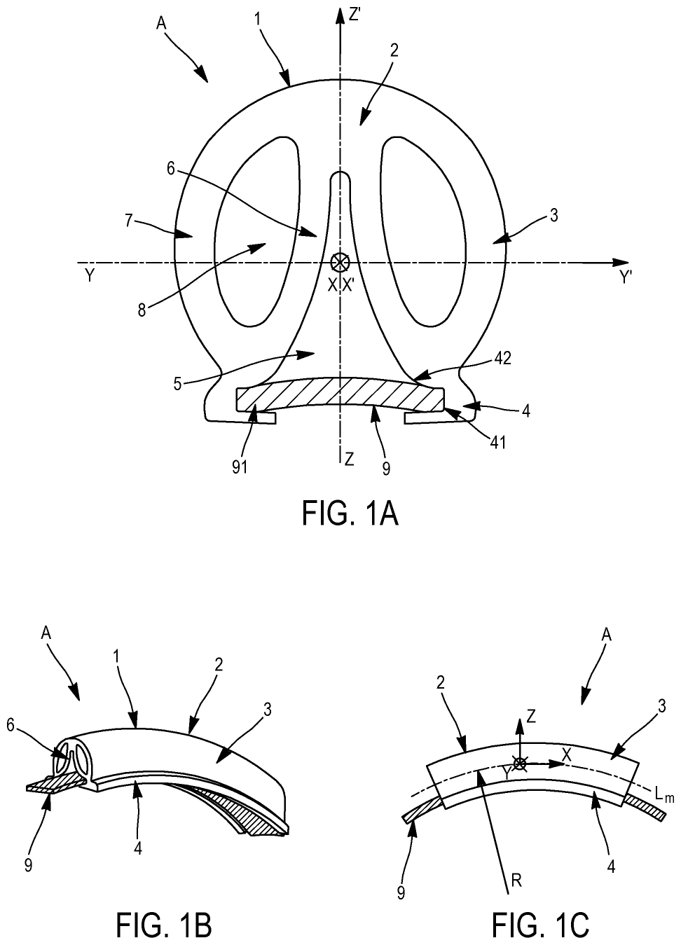

FIG. 1A: Cross section through an assembly for a tire according to the invention.

FIG. 1B: Perspective view of an assembly for a tire according to the invention.

FIG. 1C: Side view of an assembly for a tire according to the invention.

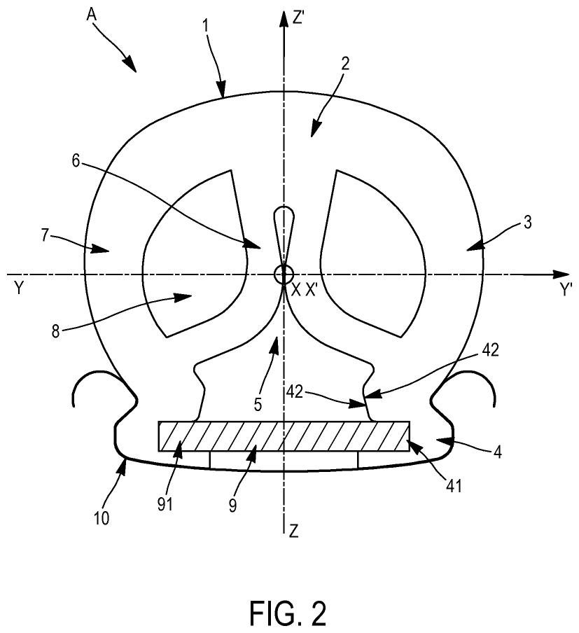

FIG. 2: Cross section through a non-pneumatic tire which is obtained by winding an assembly for a tire according to the invention, in a compressed state.

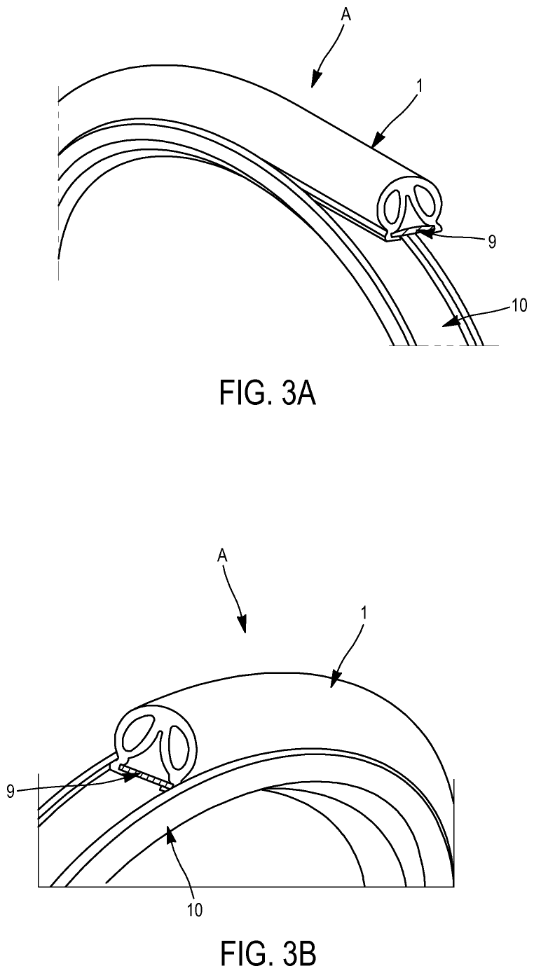

FIG. 3A: Partial perspective view of a non-pneumatic tire in the process of being created, by winding an assembly for a tire according to the invention onto a rim.

FIG. 3B: Partial perspective view of a non-pneumatic tire obtained by winding an assembly for a tire according to the invention onto a rim.

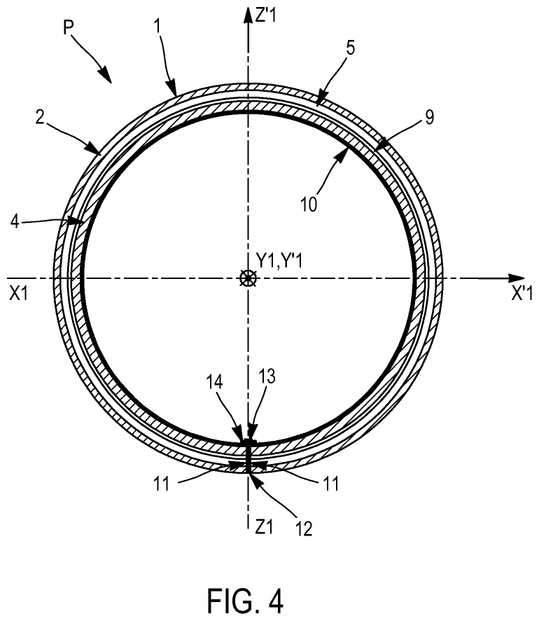

FIG. 4: Longitudinal section, in a longitudinal midplane XZ, of a non-pneumatic tire obtained by winding an assembly for a tire according to the invention onto a rim.

FIG. 1A depicts a cross section, in a transverse plane YZ, of an assembly A for a tire according to the invention. The assembly A for a tire is made up of a tire element 1 and of a clamping insert 9. The tire element 1 is a hollow tubular body comprising at least one polymer material. It comprises a crown 2, intended to come into contact with the ground, and connected by two sidewalls 3 to two beads 4 which are intended to collaborate with a rim (not depicted). The assembly consisting of the crown 2, the two sidewalls 3 and the two beads 4 delimits an open main interior cavity 5. According to the invention, the tire element 1 comprises two stiffening portions 6 at least partially not joined together, and each stiffening portion 6 extends in the open main interior cavity 5 from each bead 4 as far as the crown 2 and delimits, with a portion of the tire element 7 facing the said stiffening portion 6, a closed secondary interior cavity 8. In the preferred embodiment depicted, the two stiffening portions 6 are symmetrical with respect to the longitudinal midplane XZ, passing through the middle of the crown 2 and containing the longitudinal midline Lₘ (depicted in FIG. 1C) of the tire element 1. Furthermore, each stiffening portion 6 has, in the transverse plane YZ, a transverse curvature C₁ that has the opposite orientation to that of the transverse curvature C₀ of the portion of the tire element 7 facing the stiffening portion 6. Finally, each bead 4 comprises a longitudinal groove 41 opening onto an interior face 42 of a bead, facing the open main interior cavity 5, and extending along the entire length L of the longitudinal midline of the tire element 1. The clamping insert 9 is configured to apply a clamping force to the two beads 4 as the assembly A for a tire is wound onto the rim (not depicted). According to the invention, the clamping insert 9 is a tape, comprising two transverse edges 91 inserted in the respective longitudinal grooves 41 of the two beads 4 of the tire element 1 and has, in the transverse plane YZ, a curved cross section. FIG. 1B is a perspective view of an assembly for a tire according to the invention, the cross section of which is depicted in FIG. 1A. Finally, FIG. 1C is a side view of an assembly for a tire according to the invention, in the particular instance in which the tire element 1 has a curved longitudinal midline Lₘ having a monotonic radius of curvature R.

FIG. 2 is a cross section, in a transverse plane YZ, of a non-pneumatic tire obtained by winding an assembly for a tire according to the invention, in a compressed state. FIG. 2 adds a rim 10 to the elements depicted in FIG. 1A. The clamping insert 9, in the case depicted, has the form of a tape with a cross section that is substantially rectilinear after the assembly A for a tire has been wound onto the rim 10, the said cross section being initially curved as depicted in FIG. 1A. The clamping insert 9 extends circumferentially, in the direction XX′, over the entire circumference of the non-pneumatic tire. As the non-pneumatic tire mounted on its rim 10 is compressed onto the ground, the stiffening portions 6 come into contact with one another and, by bearing against one another via their respective exterior faces, increase the stiffness of the non-pneumatic tire with respect to compression.

FIG. 3A is a partial perspective view of a non-pneumatic tire in the process of being created, by winding an assembly A for a tire according to the invention onto a rim 10. The tire element 1, cut to a length L substantially equal to the circumference of the rim 10 and provided with a clamping insert 9 in the form of a tape, is applied progressively to the rim 10, with the beads being fitted against the rim flanges. FIG. 3B is a partial perspective view of a non-pneumatic tire obtained by winding a tire element according to the invention onto a rim and depicts the final state of the mounting thus achieved.

Finally, FIG. 4 depicts a longitudinal section, in a longitudinal midplane X1Z1, of a non-pneumatic tire P obtained by winding an assembly for a tire according to the invention onto a rim 10. The tire element 1, comprising a crown 2 and beads 4, is mounted on the rim 10, it being clamped to the rim by a clamping insert 9. The longitudinal end faces 11 of the tire element 1 are butted together circumferentially in an abutment zone constituting a circumferential through-discontinuity 12 of the tire element 1. Furthermore, the longitudinal ends of the clamping insert 9, which are joined together, are secured to the rim 10 using locking means 13 that pass through a hole 14 in the rim, which hole is positioned circumferentially plumb with the circumferential through-discontinuity 12 of the non-pneumatic tire P.

The invention has been studied more particularly for the case of a non-pneumatic tire for a bicycle of size 37-622, according to the designation of the ETRTO standard.

Such a non-pneumatic bicycle tire has a section width, in the direction YY′, equal to 37 mm and a section height, in the direction ZZ′, equal to 39 mm. It is intended to be mounted on a rim having a diameter equal to 622 mm Each stiffening portion of the tire element has a thickness equal to 3 mm and a curvilinear length, comprised between its interface with the bead and its interface with the crown, equal to 22 mm. Furthermore, each stiffening portion of the tire element has an interface with the bead which is positioned, in the direction ZZ′, at a distance, from the end of the bead, equal to 3 mm, and has an interface with the crown which is positioned, in the direction YY′, at a distance, with respect to the longitudinal midplane XZ, equal to 2 mm. The polymer material of which the tire element is made is a vulcanized thermoplastic material having a Shore A hardness equal to 86, measured at 23° C., and a cure temperature of between 175° C. and 230° C. Finally, the tire element has a curved longitudinal midline having a monotonic radius of curvature R equal to approximately 300 mm.

In the example being studied, the clamping insert is a tape, comprising two edges inserted in the respective longitudinal grooves of the two beads of the tire element, and has a cross section that is curved, before the assembly for a tire is wound onto the rim. The curved cross section has a midline having a radius equal to 15 mm, and a curvilinear length equal to 18 mm before the assembly for a tire is wound onto the rim.

The inventors have demonstrated that the stiffening of the non-pneumatic tire leads to a significant reduction in the radial deformation of the crown, or deflection. The deflection changes from 15 mm, for a reference non-pneumatic tire without a stiffening portion, to a deflection of 5 mm for a non-pneumatic tire according to the invention, with two stiffening portions, which is to say that the deflection is reduced by a factor of 3, for the same applied load.

1. An assembly (A) for a tire, made up of a tire element and of a clamping insert, and able to be wound onto a rim to constitute a non-pneumatic tire for a lightweight vehicle:
the tire element being a hollow tubular body having a longitudinal midline (Lₘ) of length L and comprising at least one polymer material,
the tire element comprising a crown, intended to come into contact with the ground, and connected by two sidewalls to two beads which are intended to collaborate with the rim,
the assembly consisting of the crown, the two sidewalls and the two beads delimiting an open main interior cavity,
each bead of the tire element comprising a longitudinal groove opening onto an interior face of a bead, facing the open main interior cavity, and extending along the entire length L of the longitudinal midline of the tire element,
the clamping insert having a longitudinal length L1 at most equal to the length L of the longitudinal midline of the tire element,
wherein the tire element comprises two stiffening portions at least partially not joined together, in that each stiffening portion extends in the open main interior cavity from each bead as far as the crown and delimits, with a portion of the tire element facing the said stiffening portion, a closed secondary interior cavity, and in that the clamping insert is a tape, comprising two transverse edges inserted in the respective longitudinal grooves of the two beads of the tire element so that the clamping insert is configured to apply a clamping force to the two beads, as the assembly (A) for a tire is wound onto the rim.

2. The assembly (A) for a tire according to claim 1, wherein the two stiffening portions of the tire element are symmetrical with respect to a longitudinal midplane (XZ), passing through the middle of the crown and containing the longitudinal midline (Lₘ) of the tire element.

3. The assembly (A) for a tire according to claim 1, wherein each portion of the tire element facing a stiffening portion has, in any transverse plane (YZ) perpendicular to the longitudinal midline (Lₘ) of the tire element, a transverse curvature C₀, wherein each stiffening portion has, in any transverse plane (YZ), a transverse curvature C₁ that has the opposite orientation to the transverse curvature C₀ of the portion of the tire element facing the stiffening portion.

4. The assembly (A) for a tire according to claim 1, wherein the tire element is made of a single polymer material.

5. The assembly (A) for a tire according to claim 4, wherein the polymer material of which the tire element is made has a Shore hardness at least equal to 70.

6. The assembly (A) for a tire according to claim 5, wherein the polymer material of which the tire element is made is a thermoplastic elastomer material or a vulcanized thermoplastic material.

7. The assembly (A) for a tire according to claim 1, wherein the tire element has a curved longitudinal midline (Lₘ) having a monotonic radius of curvature R.

8. The assembly (A) for a tire according to claim 7, wherein the clamping insert has, in any transverse plane, (YZ) a cross section that is curved, before the assembly (A) for a tire is wound onto the rim.

9. The assembly (A) for a tire according to claim 1, wherein the clamping insert is made of a polymer material, preferably a plastic material.

10. A method for mounting an assembly (A) for a tire, according to claim 1, on a rim, the assembly (A) for a tire being made up of a tire element, having a longitudinal midline (Lₘ) of length L extending between two longitudinal end faces, and a clamping insert, having a longitudinal length L1, measured between two longitudinal ends, at most equal to the length L, the method comprising:
a first step of circumferentially winding the assembly (A) for a tire onto the rim,
a second step of setting the two beads of the tire element on the rim, by the collaboration between the clamping insert and the respective longitudinal grooves of the two beads,
a third step of butting together the two longitudinal end faces of the tire element so as to constitute a non-pneumatic tire (P), the abutment zone constituting a circumferential through-discontinuity of the non-pneumatic tire (P).

11. The method for mounting an assembly (A) for a tire according to claim 10, comprising a fourth step of joining together the longitudinal ends of the clamping insert.

12. The method for mounting an assembly (A) for a tire according to claim 11, comprising a fifth step of locking the longitudinal ends of the clamping insert to the rim.
